(19) United States
(12) Patent Application Publication
(10) Pub. No.: US 2018/0333875 A1
(43) Pub. Date: Nov. 22, 2018

(54) PORTABLE BODY HAIR TRIMMER WITH COMB HEAD INSEPARABLE DESIGN

(71) Applicant: SPECIALIFE (ZHUHAI) CO., LTD., Zhuhai (CN)

(72) Inventor: Tung Yan Lau, Zhuhai (CN)

(21) Appl. No.: 15/965,858

(22) Filed: Apr. 28, 2018

(30) Foreign Application Priority Data
May 16, 2017 (CN) 201720545199.5

(51) Int. Cl. B26B 19/20; B26B 19/38

(52) U.S. Cl. CPC B26B 19/20; B26B 19/3873; B26B 19/3853

(57) ABSTRACT

The present invention provides a portable body hair trimmer with a comb head inseparable design, comprising: a body, a cutter head, and a comb head configured to be sheathed outside the cutter head, wherein a driving component configured to drive the cutter head is provided in the body, wherein the comb head is fixedly or detachably connected to the body or the cutter head. According to the present invention, the comb head and the main part of the portable body hair trimmer are designed into an integrity, and the comb head is no longer placed separately, so that the comb head will not be lost no matter if it is carried or used, and the use of the trimmer will not be affected, effectively solving the problems of the prior art.

### CROSS REFERENCES TO RELATED APPLICATION

This application claims priority of Chinese Utility Model Application No. 201720545199.5 filed on May 16, 2017, the entire contents of which are hereby incorporated by reference.

### TECHNICAL FIELD

The present invention belongs to the technical field of personal care products, in particular to the field of electric hair trimmers, and more particularly, to a portable body hair trimmer.

### BACKGROUND

A portable pen-shaped or telescopic body hair trimmer is very fine and compact in size, and it is very popular among users. Users are accustomed to putting it in a handbag or a cosmetic bag and carrying it with them so as to be conveniently used.

This type of body hair trimmers usually has a comb head which is a length limiter for trimming hair and the comb head is designed as a separate accessory. When being carried, a cutter cover is sheathed on the cutter cover of the hair trimmer and the comb head is placed separately; in use, the cutter cover is removed, and the comb head is sheathed on the cutter head for use.

The above design will obviously result in a problem: the comb head is easily lost and it is inconvenient to carry. Some brands will come with a collection box or collection bag into which the whole set of the body and the comb head is placed. This design has the disadvantage of occupying too much space and loses the advantages that the portable hair trimmer is fine and compact, and it is contrary to the design intent of easy carrying. Moreover, even if a collection box or a collection bag is used, the accessory such as a comb head may also be left at home or even be lost due to negligence.

### SUMMARY

The purpose of the present invention is to provide a new portable body hair trimmer in which a comb head and a body are inseparable for the deficiencies of the prior art. The trimmer is more portable and is not easy to be lost.

In order to achieve the above object, the present invention adopts the following technical solutions:

a portable body hair trimmer with a comb head inseparable design, comprising: a body, a cutter head, and a comb head configured to be sheathed outside the cutter head, wherein a driving component configured to drive the cutter head is provided in the body, wherein the comb head is fixedly or detachably connected to the body or the cutter head.

Preferably, the body hair trimmer is a telescopic body hair trimmer, the body of the body hair trimmer comprises a shell, and the cutter head telescopically goes in and out from one end of the shell; the comb head is sheathed outside the cutter head and expands and contracts with the cutter head, and the end of the shell matches the shape of the comb head so that when the cutter head goes in and out from the end of the shell with the comb head, the comb head does not come off.

The end of the shell is provided with a notch matching the shape of the comb head, so that when the cutter head is contracted into the end of the shell with the comb head, any portion of the comb head does not protrude beyond the end of the shell.

Preferably, the comb head is elongated, the comb head has a plurality of bar-shaped comb teeth, and each of the comb teeth extends along the circumferential direction of the comb head and is evenly distributed along the axial direction of the comb head. The bar-shaped comb teeth protrude from the comb head body so as to be capable of easily combing hair and be also capable of playing a massaging role on the scalp to some extent.

Preferably, the comb teeth are arranged in two rows, there is a one-to-one correspondence between the comb teeth on each row, and there is a gap between the comb teeth having a one-to-one correspondence. When combing hair, hair may enter between the comb teeth from the end of the comb teeth or enter between the comb teeth from the gap between the comb teeth. This structure makes it easier to comb hair.

Preferably, the shell has an arc-shaped first side surface, the notch is provided on the first side surface, each of the comb teeth is arc-shaped, and when the comb head is contracted into the shell, all the comb teeth are located in the notch and the outer side surfaces of all the comb teeth are flush with the first side surface. The shell has an arc-shaped first side surface. When the user grasps the shell of the body by hand, the palm is in contact with the first side surface, which can improve the comfort of the grasp. When the comb head is contracted into the shell, all the comb teeth are located in the notch because the outer side surfaces of all the comb teeth are flush with the first side surface. All the comb teeth will not protrude outwardly with respect to the shell, so the comb teeth will not increase the overall volume of the body excessively at this time. In this way, the body hair trimmer is more compact in structure and easy to carry; in addition, all the comb teeth will not be recessed inwardly with respect to the shell, so the comb teeth will not form a groove with the outer wall of the shell, so that it is not easy for the shell to gather dust.

Preferably, the comb head has an inner boss and an outer boss which are oppositely arranged, both the inner boss and the outer boss are arc-shaped, all the comb teeth are located between the inner boss and the outer boss, and both the outer side surface of the inner boss and the outer side surface of the outer boss are flush with the first side surface. In this structure, the inner boss and the outer boss protect the comb teeth, so that the comb teeth are not easily damaged due to collision. The inner boss and the outer boss will not protrude outwardly with respect to the shell, so the inner boss and the outer boss will not increase the overall volume of the body excessively at this time. In this way, the body hair trimmer is more compact in structure and easy to carry; in addition, the inner boss and the outer boss will not be recessed inwardly with respect to the shell, so the inner boss and the outer boss will not form a groove with the outer wall of the shell, so that it is not easy for the shell to gather dust.

Preferably, when the comb head is contracted into the shell, both the inner boss and the outer boss are located in the notch, and the inner side surface of the inner boss is abutted against the inner wall of the notch, and the outer side surface of the outer boss is flush with the end of the shell. In this structure, the outer boss will not protrude outwardly with respect to the shell along the axial direction of the shell, so the outer boss will not increase the overall volume of the body excessively at this time. In this way, the body hair trimmer is more compact in structure and easy to carry; in addition, the outer boss will not be recessed inwardly with respect to the shell along the axial direction of the shell, so the outer boss will not form a groove with the outer wall at the end of the shell, so that it is not easy for the shell to gather dust; similarly the inner side surface of the inner boss is abutted against the inner wall of the notch, so that it is not easy for the shell to gather dust either.

Preferably, the notch has two side walls which are oppositely arranged, each of the side walls is arc-shaped, the comb head has two sliding guiding surfaces, and both of the sliding guiding surfaces are arc-shaped and are located at both sides of the inner boss, respectively, and each of the sliding guiding surfaces is capable of being abutted against one side wall of the notch, respectively. Under the drive of the driving component, in the process that the comb head is contracted into the shell, each of the sliding guiding surfaces is abutted against one side wall of the notch, respectively. The sliding guiding surfaces and the side wall of the notch form a guiding structure which can play a good guiding role in the movement of the comb head, so that the comb head is contracted into the notch more stably and accurately.

Preferably, the body hair trimmer is a pen-shaped body hair trimmer and further comprises a cutter cover, and a notch corresponding to the shape of the comb head is provided at the position, corresponding to the comb head, of the cutter cover, so that the comb head and the cutter cover are detachably combined and are sheathed outside the cutter head together.

Optionally, the body hair trimmer is a pen-shaped body hair trimmer and further comprises a cutter cover, the comb head is a part of the cutter cover, and when the cutter cover is sheathed outside the cutter head, the comb head is located just outside the shearing part of the cutter head.

The comb head is located at an end of the cutter cover.

Preferably, the comb head and the cutter cover are detachably combined.

A body shell is sheathed outside the body, and the body shell is provided with a notch matching the shape of the comb head so that the comb head is detachably provided at the notch in a snap-in manner.

Preferably, the body shell is a battery cover on the body.

When the body hair trimmer is a pen-shaped body hair trimmer, the body hair trimmer further comprises a cutter cover, and the cutter cover and the comb head are alternately sheathed outside the cutter head according to use conditions.

Compared with the prior art, the advantages of the present invention are as follows.

The comb head and the main part of the portable body hair trimmer are designed into an integrity, and the comb head is no longer placed separately, so that the comb head will not be lost no matter if it is carried or used, and the use of the trimmer will not be affected, effectively solving the problems of the prior art.

### BRIEF DESCRIPTION OF THE DRAWINGS

FIG. 1 and FIG. 2 are schematic diagrams illustrating a carrying state and a using state according to embodiment 1 of the present invention, respectively.

FIG. 3 and FIG. 4 are schematic diagrams illustrating a carrying state and a using state according to embodiment 2 of the present invention, respectively.

FIG. 5 and FIG. 6 are schematic diagrams illustrating a detaching state and a using state of an integrated structure of a comb cover and a comb head according to embodiment 3 of the present invention, respectively.

FIG. 7 and FIG. 8 are schematic diagrams illustrating a carrying state and a using state according to embodiment 4 of the present invention, respectively.

### DESCRIPTION OF THE EMBODIMENTS

The present invention and its beneficial effects will be further described in detail with reference to specific embodiments. However, the specific embodiments of the present invention are not limited thereto.

### Embodiment 1

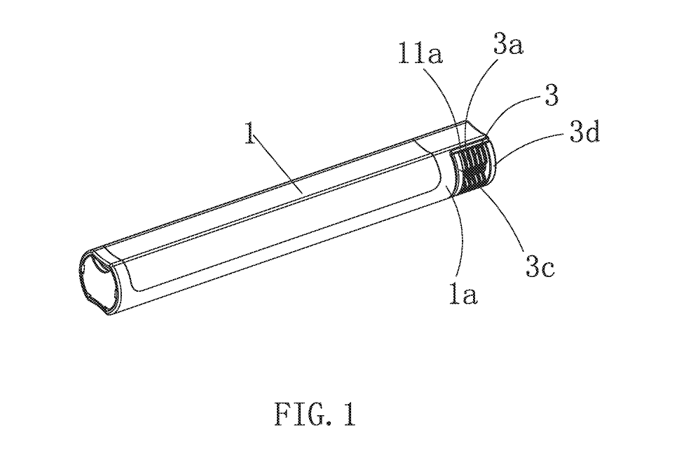

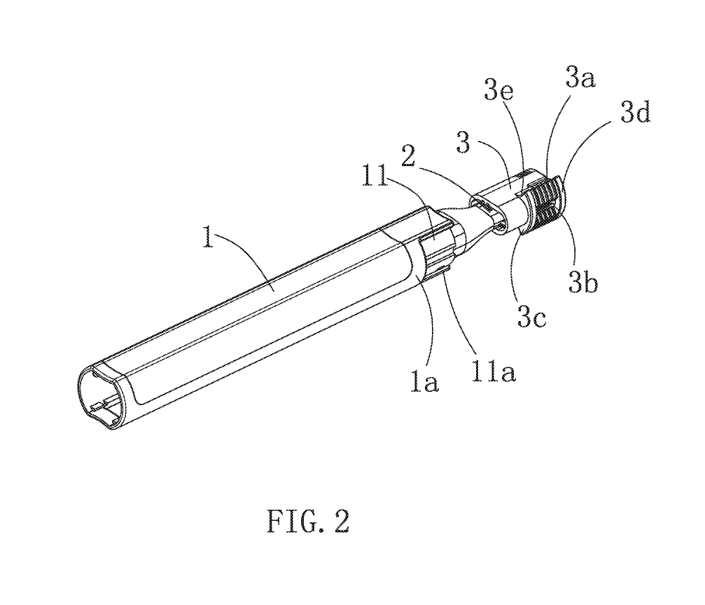

As shown in FIG. 1 and FIG. 2, the present embodiment provides a telescopic body hair trimmer, comprising: a body 1, a cutter head 2, and a comb head 3 configured to be sheathed outside the cutter head 2 (specifically, a shearing part corresponding to the cutter head). A driving component configured to drive the cutter head 2 is provided in the body 1. The body 1 comprises a shell, and the cutter head 2 may telescopically go in and out from one end of the shell. The end of the shell is provided with a notch 11 matching the shape of the comb head 3, so that the comb head 3 sheathed outside the cutter head 2 may telescopically go in and out from the notch 11 of the shell with the cutter head 2. Moreover, when the cutter head 2 is contracted into the end of the shell with the comb head 3, any portion of the comb head 3 does not protrude beyond the end of the shell. In use, the cutter head 2 is pulled out with the comb head 3. After use, the cutter head 2 is contracted into the shell with the comb head 3 together to facilitate carrying. That is, in the present embodiment, a cutter cover is not provided.

In addition, the comb head 3 can be removed out of the cutter head 2.

In the present embodiment, the telescopic manner of the cutter head with the comb head is a conventional design, which will not be described in detail herein.

As shown in FIG. 1 and FIG. 2, in the present embodiment, the comb head 3 is elongated, the comb head 3 has a plurality of bar-shaped comb teeth 3a, and each of the comb teeth 3a extends along the circumferential direction of the comb head 3 and is evenly distributed along the axial direction of the comb head 3. The bar-shaped comb teeth 3a protrude from the comb head 3 body so as to be capable of easily combing hair and be also capable of playing a massaging role on the scalp to some extent.

As shown in FIG. 1 and FIG. 2, in the present embodiment, the comb teeth 3a are arranged in two rows, there is a one-to-one correspondence between the comb teeth 3a on each row, and there is a gap 3b between the comb teeth 3a having a one-to-one correspondence. When combing hair, hair may enter between the comb teeth 3a from the end of the comb teeth 3a or enter between the comb teeth 3a from the gap between the comb teeth 3a. This structure makes it easier to comb hair.

As shown in FIG. 1 and FIG. 2, preferably, the shell has an arc-shaped first side surface 1a, the notch 11 is provided on the first side surface 1a, each of the comb teeth 3a is arc-shaped, and when the comb head 3 is contracted into the shell, all the comb teeth 3a are located in the notch 11 and the outer side surfaces of all the comb teeth 3a are flush with the first side surface 1a. The shell has an arc-shaped first side surface 1a. When the user grasps the shell of the body 1 by hand, the palm is in contact with the first side surface 1a, which can improve the comfort of the grasp. When the comb head 3 is contracted into the shell, all the comb teeth 3a are located in the notch 11 because the outer side surfaces of all the comb teeth 3a are flush with the first side surface 1a. All the comb teeth 3a will not protrude outwardly with respect to the shell, so the comb teeth 3a will not increase the overall volume of the body 1 excessively at this time. In this way, the body hair trimmer is more compact in structure and easy to carry; in addition, all the comb teeth 3a will not be recessed inwardly with respect to the shell, so the comb teeth 3a will not form a groove with the outer wall of the shell, so that it is not easy for the shell to gather dust.

As shown in FIG. 1 and FIG. 2, in the present embodiment, the comb head 3a has an inner boss 3c and an outer boss 3d which are oppositely arranged, both the inner boss 3c and the outer boss 3d are arc-shaped, all the comb teeth 3a are located between the inner boss 3c and the outer boss 3d, and both the outer side surface of the inner boss 3c and the outer side surface of the outer boss 3d are flush with the first side surface 1a. In this structure, the inner boss 3c and the outer boss 3d protect the comb teeth 3a, so that the comb teeth 3a are not easily damaged due to collision. The inner boss 3c and the outer boss 3d will not protrude outwardly with respect to the shell, so the inner boss 3c and the outer boss 3d will not increase the overall volume of the body 1 excessively at this time. In this way, the body hair trimmer is more compact in structure and easy to carry; in addition, the inner boss 3c and the outer boss 3d will not be recessed inwardly with respect to the shell, so the inner boss 3c and the outer boss 3d will not form a groove with the outer wall of the shell, so that it is not easy for the shell to gather dust.

As shown in FIG. 1 and FIG. 2, in the present embodiment, when the comb head 3 is contracted into the shell, both the inner boss 3c and the outer boss 3d are located in the notch 11, and the inner side surface of the inner boss 3c is abutted against the inner wall of the notch 11, and the outer side surface of the outer boss 3d is flush with the end of the shell. In this structure, the outer boss 3d will not protrude outwardly with respect to the shell along the axial direction of the shell, so the outer boss 3d will not increase the overall volume of the body excessively at this time. In this way, the body hair trimmer is more compact in structure and easy to carry; in addition, the outer boss 3d will not be recessed inwardly with respect to the shell along the axial direction of the shell, so the outer boss 3d will not form a groove with the outer wall at the end of the shell, so that it is not easy for the shell to gather dust; similarly the inner side surface of the inner boss 3c is abutted against the inner wall of the notch 11, so that it is not easy for the shell to gather dust either.

As shown in FIG. 1 and FIG. 2, in the present embodiment, the notch 11 has two side walls 11a which are oppositely arranged, each of the side walls 11a is arc-shaped, the comb head 3 has two sliding guiding surfaces 3e, and both of the sliding guiding surfaces 3e are arc-shaped and are located at both sides of the inner boss 3c, respectively, and each of the sliding guiding surfaces 3e is capable of being abutted against one side wall 11a of the notch 11, respectively. Under the drive of the driving component, in the process that the comb head 3 is contracted into the shell, each of the sliding guiding surfaces 3e is abutted against one side wall 11a of the notch 11, respectively. The sliding guiding surfaces 3e and the side wall 11a of the notch 11 form a guiding structure which can play a good guiding role in the movement of the comb head 3, so that the comb head 3 is contracted into the notch 11 more stably and accurately.

### Embodiment 2

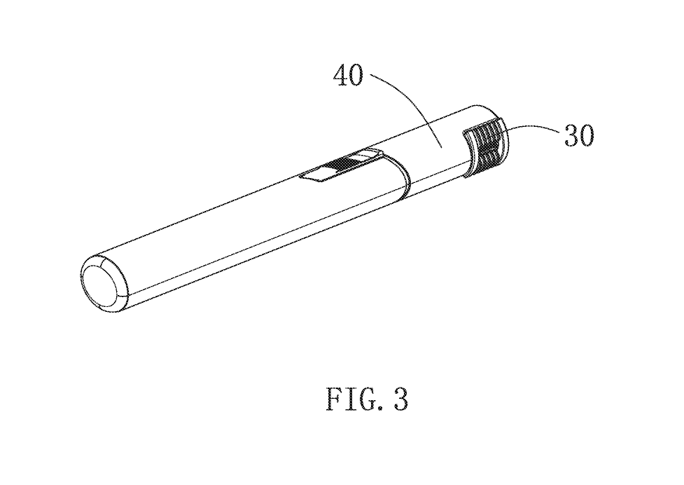

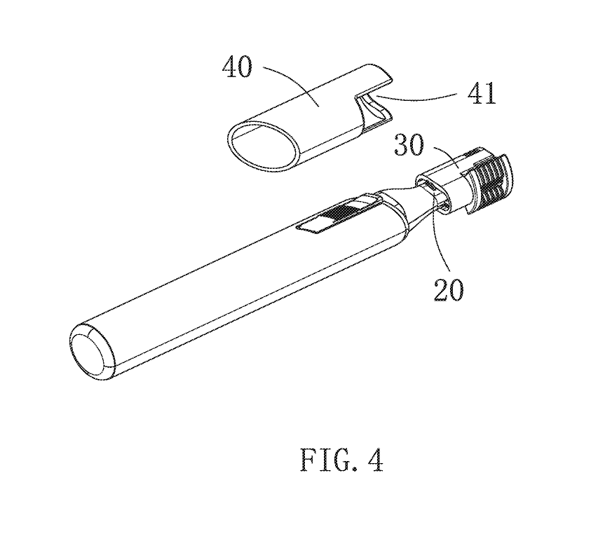

As shown in FIG. 3 and FIG. 4, the present embodiment provides a pen-shaped body hair trimmer, which is different from embodiment 1 in that the body hair trimmer further comprises a cutter cover 40, and a notch 41 corresponding to the shape of the comb head 30 is provided at the position, corresponding to the comb head 30, of the cutter cover 40. The comb head 30 and the cutter cover 40 are detachable and are also capable of being sheathed outside the cutter head 20 together after being correspondingly installed together. Moreover, the structure of the cutter cover 40 and the comb head 30 is such that when the cutter cover 40 is removed, the fixed position of the comb head 30 is not affected, that is, the comb head 30 will not be driven to move. In use, the cutter cover 40 is removed. Since the comb head 30 is not moved, it can be used directly. When being carried, the cutter cover 40 only needs to be covered.

### Embodiment 3

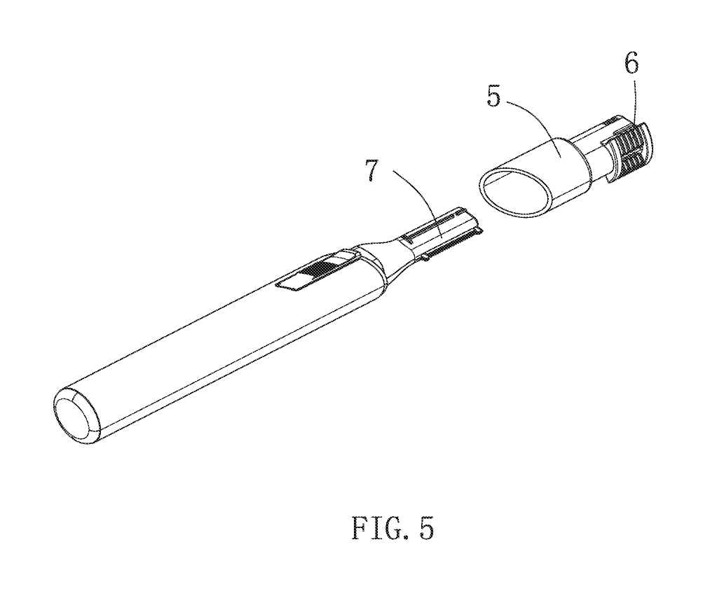

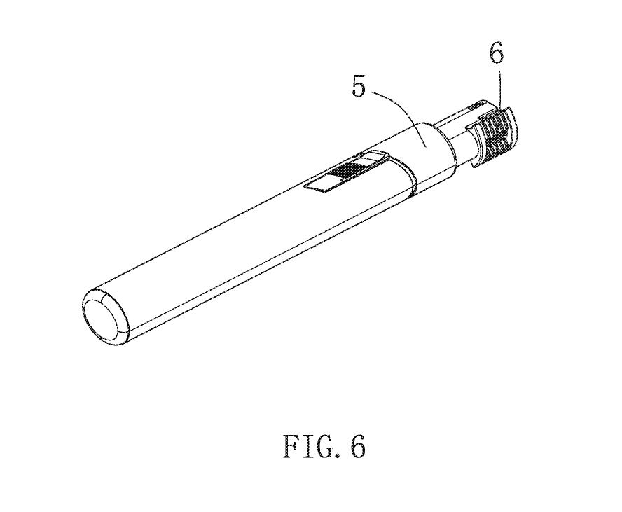

As shown in FIG. 5 and FIG. 6, the present embodiment further provides a pen-shaped body hair trimmer, which is different from embodiment 2 in that the cutter cover 5 and the comb head 6 of the body hair trimmer are integrally designed, and may be formed integrally or may be fixed together after being formed separately so that the comb head 6 becomes a part of the cutter cover 5 and is non-detachable. The structure of the cutter cover 5 and the comb head 6 can be such that after the cutter cover 5 with the comb head 6 is sheathed outside the cutter head 7, the comb head 6 is located just outside the shearing part of the cutter head 7. In use, it can be used directly without any detachment and change. When being carried, the cutter head 7 can also be effectively protected. The integral structure of the comb head 6 and the cutter cover 5 can also be removed by the pen-shaped body hair trimmer and placed separately.

### Embodiment 4

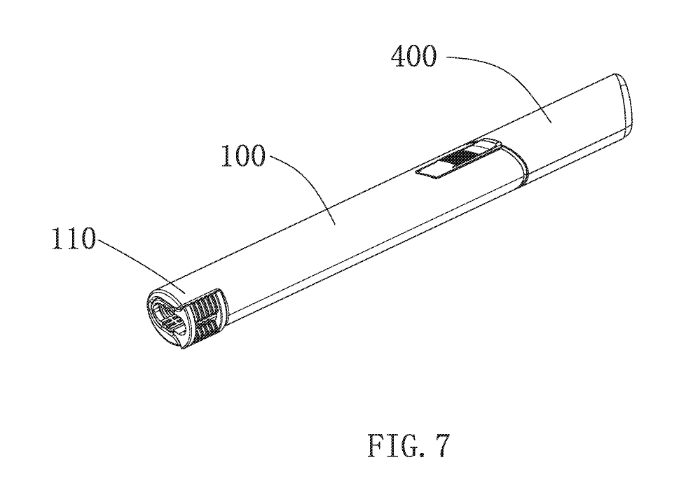

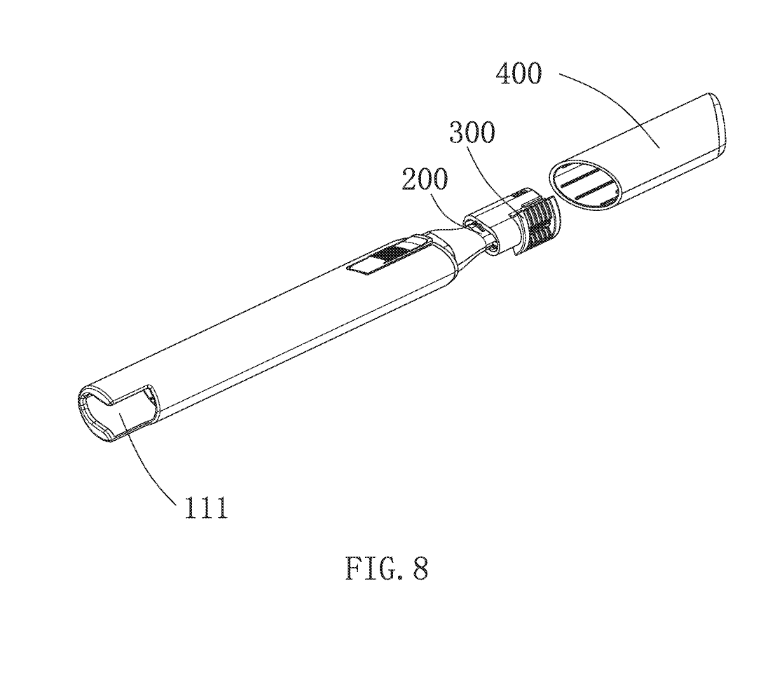

As shown in FIG. 7 and FIG. 8, the present embodiment further provides a pen-shaped body hair trimmer, which is different from embodiments 2 and 3 in that a battery cover 110 is provided at the position, corresponding to the battery in the body, on the body 100. The battery cover 110 is provided with a notch 111 matching the shape of the comb head 300 so that the comb head 300 is detachably provided at the notch 111 in a snap-in manner. The cutter cover 400 has a conventional design and is sheathed outside the cutter head 200.

In use, the cutter cover 400 is removed, and the comb head 300 is removed from the battery cover 110 and is installed outside the blade head 200; when being carried, the cutter cover 400 is sheathed outside the blade head 200 in a conventional manner, and the comb head 300 is installed and fixed at the notch 111 of the battery cover 110.

The designs of the above embodiments 1 to 4 are not limited to be applied to a pen-shaped body hair trimmer, and may also be applied to other small body hair trimmers. The above embodiments 1 to 3 may also be applied to a separately sold replacement cutter head of a small body hair trimmer. Moreover, in embodiment 4, the comb head is not limited to being mounted on the battery cover, and may be attached to other positions of the body shell as long as the operation of the mechanism in the body is not affected.

Therefore, the present invention is not limited to the above specific embodiments. All obvious improvement, replacement or modification made by those skilled in the art based on the present invention belongs to the protection scope of the present invention. In addition, although some specific terms are used in this specification, these terms are only for convenience of description and do not constitute any limitation on the present invention.

What is claimed is:

1. A portable body hair trimmer with a comb head inseparable design, comprising: a body, a cutter head, and a comb head configured to be sheathed outside the cutter head, wherein a driving component configured to drive the cutter head is provided in the body, wherein the comb head is fixedly or detachably connected to the body or the cutter head.

2. The body hair trimmer according to claim 1, wherein the body hair trimmer is a telescopic body hair trimmer, the body of the body hair trimmer comprises a shell, and the cutter head telescopically goes in and out from one end of the shell; the comb head is sheathed outside the cutter head and expands and contracts with the cutter head, and the end of the shell matches the shape of the comb head so that when the cutter head goes in and out from the end of the shell with the comb head, the comb head does not come off.

3. The body hair trimmer according to claim 2, wherein the end of the shell is provided with a notch matching the shape of the comb head, so that when the cutter head is contracted into the end of the shell with the comb head, any portion of the comb head does not protrude beyond the end of the shell.

4. The body hair trimmer according to claim 3, wherein the comb head is elongated, the comb head has a plurality of bar-shaped comb teeth, and each of the comb teeth extends along the circumferential direction of the comb head and is evenly distributed along the axial direction of the comb head.

5. The body hair trimmer according to claim 4, wherein the comb teeth are arranged in two rows, there is a one-to-one correspondence between the comb teeth on each row, and there is a gap between the comb teeth having a one-to-one correspondence.

6. The body hair trimmer according to claim 4, wherein the shell has an arc-shaped first side surface, the notch is provided on the first side surface, each of the comb teeth is arc-shaped, and when the comb head is contracted into the shell, all the comb teeth are located in the notch and the outer side surfaces of all the comb teeth are flush with the first side surface.

7. The body hair trimmer according to claim 5, wherein the comb head has an inner boss and an outer boss which are oppositely arranged, both the inner boss and the outer boss are arc-shaped, all the comb teeth are located between the inner boss and the outer boss, and both the outer side surface of the inner boss and the outer side surface of the outer boss are flush with the first side surface.

8. The body hair trimmer according to claim 5, wherein when the comb head is contracted into the shell, both the inner boss and the outer boss are located in the notch, and the inner side surface of the inner boss is abutted against the inner wall of the notch, and the outer side surface of the outer boss is flush with the end of the shell.

9. The body hair trimmer according to claim 3, wherein the notch has two side walls which are oppositely arranged, each of the side walls is arc-shaped, the comb head has two sliding guiding surfaces, and both of the sliding guiding surfaces are arc-shaped and are located at both sides of the inner boss, respectively, and each of the sliding guiding surfaces is capable of being abutted against one side wall of the notch, respectively.

10. The body hair trimmer according to claim 1, wherein the body hair trimmer is a pen-shaped body hair trimmer and further comprises a cutter cover, and a notch corresponding to the shape of the comb head is provided at the position, corresponding to the comb head, of the cutter cover, so that the comb head and the cutter cover are detachably combined and are sheathed outside the cutter head together.

11. The body hair trimmer according to claim 1, wherein the body hair trimmer is a pen-shaped body hair trimmer and further comprises a cutter cover, the comb head is a part of the cutter cover, and when the cutter cover is sheathed outside the cutter head, the comb head is located just outside the shearing part of the cutter head.

12. A body hair trimmer according to claim 11, wherein the comb head is located at an end of the cutter cover.

13. The body hair trimmer according to claim 1, wherein a body shell is sheathed outside the body, and the body shell is provided with a notch matching the shape of the comb head so that the comb head is detachably provided at the notch in a snap-in manner.

14. The body hair trimmer according to claim 13, wherein the body shell is a battery cover on the body.

15. The body hair trimmer according to claim 13, wherein the body hair trimmer is a pen-shaped body hair trimmer and further comprises a cutter cover, and the cutter cover and the comb head are alternately sheathed outside the cutter head according to use conditions.
